(19) United States
(12) Patent Application Publication
(10) Pub. No.: US 2015/0180876 A1
(43) Pub. Date: Jun. 25, 2015

(54) AUTHENTICATED DISTRIBUTION OF COPIES FROM A STORED ELECTRONIC RECORD VERIFIED PAGE BY PAGE

(71) Applicant: Ghada Young, Rancho Palos Verdes, CA (US)

(72) Inventor: Ghada Young, Rancho Palos Verdes, CA (US)

(21) Appl. No.: 14/588,898

(22) Filed: Jan. 2, 2015

Related U.S. Application Data
(60) Provisional application No. 61/920,479, filed on Dec. 24, 2013.

(51) Int. Cl. H04L 29/06

(52) U.S. Cl. CPC H04L 63/101

(57) ABSTRACT

Exemplary embodiments of methods and systems for authenticated distribution of copies from a stored electronic record verified page-by-page are disclosed. An original digitized document file is received by way of a secure web site. A signature image unique to the document originator is uploaded to the web site. A list of authorized recipients having respective recipient identifications is obtained. A marked document file corresponding to each of the authorized recipients is generated, wherein each marked document file includes a multiplicity of pages and displays respective testimonial content and bibliographic content. Substantially each of the pages is marked with a website seal corresponding to the secure website, the signature image, and the respective recipient identification. Each marked document file may be distributed for delivery to its respective authorized recipients. Users may register so that the documents distributed to them are securely stored, re-formatable and electronically accessible by the respective user.

### RELATED APPLICATIONS

This application claims the benefit of U.S. Provisional Patent Application No. 61/920,479 filed on Dec. 24, 2013.

### TECHNICAL FIELD

The invention relates in general to authenticated documents such as certified court reporter transcripts and, in particular, to a secure online repository that provides authentication in which substantially each separate substantive page is independently authenticated as to both origin and custody, as well as identification of authorized recipient of the respective copy.

### BACKGROUND

Court reporter transcripts have long been prepared in paper form and authenticated by the signatures of the court reporters on certificates at the end of the transcript. Sometimes the signatures of the witnesses, on original copies of the paper transcripts, also appear. Much of the process of preparing such transcripts has been automated and transcripts are generally available in electronic form. See, for example, Bennett et al. U.S. Pat. Nos. 5,970,141 and 6,282,510. Various symmetrical and asymmetrical encryption schemes are widely used to authenticate electronic data. Digital signatures, for example, are widely used in electronic commerce to authenticate electronic information. Elaborate schemes for authenticating a person's electronic affirmation of a document have been proposed. See, for example, Smithies U.S. Pat. No. 6,091,835. Methods have been proposed for inserting electronic signatures (not digital signatures) or other pre-recorded data fragments into e-mail messages. See, for example, Apfel et al U.S. Pat. No. 6,510,453. It had been proposed to impose a court reporter's signature as a non-transferable watermark on the reporter's certificate, and to print it at the bottom of every page of the transcript. It had been proposed that internet service providers be allowed to insert images (typically, advertisements such as banner ads) into predefined spaces on web pages as they are viewed by end users. See, for example, Capek U.S. Pat. No. 6,112,192.

Court reporter transcripts are unique in the particular requirements that are imposed on them. They are typically a verbatim record of sworn testimony, and they must, above all else, be accurate and remain accurate. The Courts rely on them in dispensing justice, and legislatures rely on them in making laws. Attorneys rely on them in shaping the presentation of cases. For the most part they must remain confidential unless and until placed on the public record. Witnesses typically must have access to them for purposes of review and correction. In a given matter some witnesses may have access to some but not all transcripts, and some but not all parties may have access to any given transcript or exhibit or a portion thereof. Security rights need to be tailored to fit each unique situation. Everyone involved must be sure that all transcripts are accurate and that each individual transcript is handled according to the individual rules for security rights that apply to that transcript. Also, transcripts are seldom used in their entirety. They are generally excerpted. This complicates the authentication of the excerpts. All of these often competing requirements can be handled manually by knowledgeable experienced people. Automating the system has proven to be a substantial and not yet fully addressed challenge.

There is a problem with the authentication of court reporter transcripts that is generally unique to such transcripts. Official transcripts in paper form are typically bound so that the signature pages appear within the bindings. Thus, being bound with the signature pages authenticates the other pages in the official transcript. Usually, however, only a few pages of the transcript are needed for a particular purpose. When a few pages are copied from an official transcript, a separate oath, or the like, must be used to authenticate them. When only a few pages are reproduced from an electronic file of a transcript, authentication becomes a serious problem. An electronic file is subject to being altered, and such alteration, under certain circumstances, leaves no trace. Exhibits are typically attached to a transcript. Such exhibits, particularly when in digital form, are also subject to undetectable alteration, and require authentication. Physical exhibits are typically represented by images. When reduced to digital form, most exhibits appear in image file formats. The transcript itself generally, but not necessarily, appears in a text file format.

The use of online repositories for transcripts (and other documents) had been proposed. In general, such depositories are in the form of secure web sites. Transcripts are deposited on such web sites in digital form with access to the transcripts being controlled by a system of security rights. Such security rights typically include at least user names and passwords. Often, such online repositories are maintained by or for, and are open to only one entity, such as a law firm. That is, they are not available to the public. There is always some risk that a transcript or exhibit will be altered while on such online repositories. That is, the integrity of the custody of the transcript while it is on the online repository is a potential problem. Further, records, or portions thereof are typically downloaded by various users from online repositories, and reproduced for purposes of inclusion in briefs or the like. The integrity of the substantive pages that are so reproduced by users needs to be assured on a page by page basis both as to the origin and custody of the each page. Anyone who relies on the content of a particular substantive page needs to be assured that the page accurately reflects the event described therein, was not altered in any way while on the repository, and was not altered when reproduced by the user. For purposes of flexibility of use, the authentication needs to proceed page by page.

Former expedients such as those disclosed and claimed in U.S. Pat. No. 7,665,141 provide particular solutions addressing the need for an improved all electronic official record where each substantive page of the record, including pages that are images, pages that are text, mixed pages, and the like, are separately authenticated both as to creation and custody. This permits each page to be reproduced and used separate and apart from the rest of the record with assurances that it is a true copy of the record. However, those concerned with these problems also recognize the need to provide such advantages in addition to an improved means to authenticate to whom copies of such records have been distributed.

These and other difficulties of the prior art have been overcome according to the present invention.

### SUMMARY

Certain deficiencies of the prior art may be overcome by the provision of a method of operating a secure website configured to facilitate the receipt, custody, controlled access and distribution of a plurality of separate items of the digitized content.

An original digitized document file (such as a proceeding transcript) having a respective named document originator (such a court reporter) may be received by way of the aforementioned secure website. A signature image unique to the document originator may be uploaded to the web site. A list of authorized recipients having respective recipient identifications (e.g., the recipients' legal names) may be obtained. A marked document file corresponding to each of the authorized recipients may be generated, wherein each marked document file includes a multiplicity of pages and displays respective testimonial content and bibliographic content. Substantially each of the pages is marked with a website seal corresponding to the secure website, the signature image, and the respective recipient identification. Each marked document file may be distributed for delivery to its respective authorized recipients. Users may register so that the documents distributed to them are securely stored, re-formatable and electronically accessible when and where such access is most convenient.

A witness may be enabled to review the testimonial content, provide any corrections to the testimonial content, and input a witness signature for association with the testimonial content. The witness may be emailed or otherwise provided the ability to electronically sign a document they have reviewed and/or corrected. A witness certification page displaying the witness signature may then be constructed. An errata sheet specifying the corrections may be produced if the witness has provided any corrections. In such embodiments, the step of distributing preferably includes distributing the witness certification page and any respective errata sheet for delivery to each authorized recipient.

Additional features and processes are described which facilitate the authentication of audio transcripts, and optical coding to aid in further authentication of distributed copies.

The present invention finds application in a wide variety of situations beyond that of official judicial records. For example, some business meetings and transactions require complete and accurate permanent records of the events. Also, many legislative and executive proceedings require such complete records.

Other objects, advantages, and novel features of the present invention will become apparently from the following detailed description of the invention when considered in conjunction with the accompanying drawings.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 is a diagrammatic block diagram depicting one non-limiting embodiment of a method in accordance with the present invention;

FIG. 2 is a diagrammatic block diagram depicting one non-limiting embodiment of a system and process workflow in accordance with the present invention;

FIG. 3 is a diagrammatic view of a court reporter's transcript prepared according one or more embodiments of the present invention; and

FIG. 4 is a diagrammatic high-level representation of the different entities and their relationships associated with the practice of certain embodiments of the present invention.

### DETAILED DESCRIPTION OF THE PREFERRED EMBODIMENTS

Embodiments of the present invention comprise a method of operating a secure web site for storing and distributing digitized content that is authenticated. The secure web site provides for the receipt, custody, controlled access and distribution of a plurality of separate items of the digitized content. The digitized content is received from a plurality of sources and stored on the secure web site for distribution to a plurality of authorized recipients and/or registered users under controls that assure the authenticity of the separate items that are distributed.

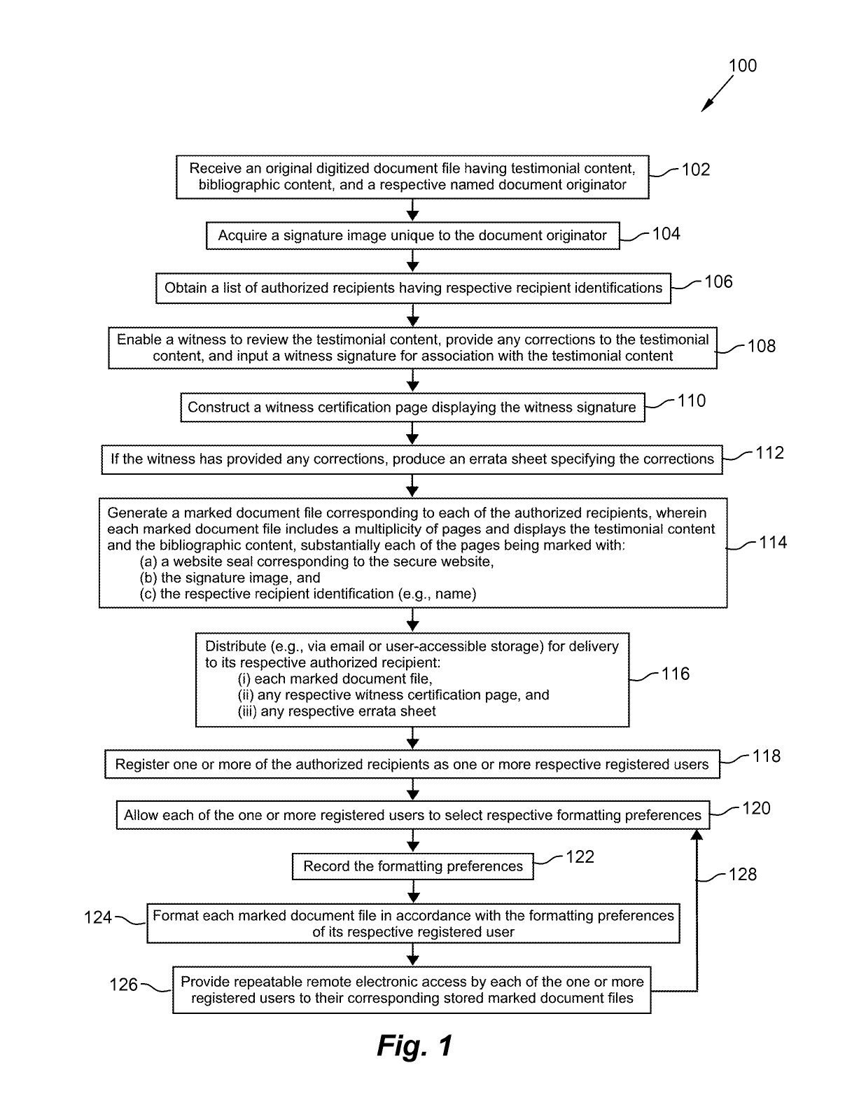

Referring now to the drawings, like reference numerals designate identical or corresponding features throughout the several views. Shown generally at 100 in FIG. 1 is one non-limiting embodiment of a method in accordance with present invention. Such method is preferably one of operating a secure website configured to facilitate the receipt, custody, controlled access and distribution of a plurality of separate items of the digitized content. In certain embodiments, the invention may be defined significantly or entirely by a non-transitory computer-readable storage media storing one or more sequences of instructions which, when executed by one or more processors cause the one or more processors to collective perform the methods discussed herein.

Referring again to FIG. 1, at block 102, an original digitized document file having for example testimonial content, bibliographic content, and a respective named document originator may be received by, for example, the aforementioned secure web site. The term “secure web site” is intended to include any servers, databases and other components which may be involved in the operation of a secure web site. The term “document file” may in some cases be used interchangeably herein with the term “ITEM.” Similarly, the term “digitized document file” may be used interchangeably herein with the term “ITEM of digitized content.” At block 104, a signature image unique to the document originator (e.g., court reporter) may be acquired by, for example, the secure web site. At block 106, a list of authorized recipients having respective recipient identifications (e.g., the recipients' legal names) may be obtained. At block 114, a marked document file corresponding to each of the authorized recipients may be generated, wherein each marked document file typically includes a multiplicity of pages and displays the testimonial content and the bibliographic content. In preferred embodiments, substantially each of the pages is marked with: (a) a website seal corresponding to the secure website, (b) the signature image, and (c) the respective recipient identification. At block 116, each marked document file may be distributed for delivery to its respective authorized recipient.

Certain preferred embodiments of the methods disclosed herein involve additional steps to facilitate the interaction and input of a witness. By way of example, referring again to FIG. 1, at block 108 a witness may be enabled to review the testimonial content, provide any corrections to the testimonial content, and input a witness signature for association with the testimonial content. In embodiments, the witness may be emailed or otherwise provided the mechanism to electronically sign a document they have reviewed or corrected. Further, the IP address of the witness accessing the secure web site 134 may be collected at the time of electronic signing by the witness. At block 110, a witness certification page displaying the witness signature may be constructed. At block 112, an errata sheet specifying the corrections may be produced if the witness has provided any corrections. In such embodiments, the step of distributing preferably includes distributing the witness certification page and any respective errata sheet for delivery to each authorized recipient.

In particular embodiments, the step of distributing may be performed at least by way of email to one or more of the respective authorized recipients. However, referring to block 118 for example, in certain preferred embodiments one or more of the authorized recipients may be registered, at their election, as one or more respective registered users. In such preferred embodiments, the marked document files corresponding to the one or more registered users may be stored (e.g., at block 116) in, for example, a memory element of the secure web site. At block 126, each of these one or more registered users may be conveniently provided repeatable remote electronic access by to their corresponding stored marked document files.

Embodiments that afford registered users repeatable remote access to their stored marked document files may preferably allow each of the one or more registered users to select respective formatting preferences (see, for example, block 120). At block 122, such formatting preferences may be recorded. At block 124, respective marked document files would be formatted in accordance with the formatting preferences of its registered user. As indicated at 128, a user may repeatedly modify his or her formatting preferences, and then re-access their corresponding store document files.

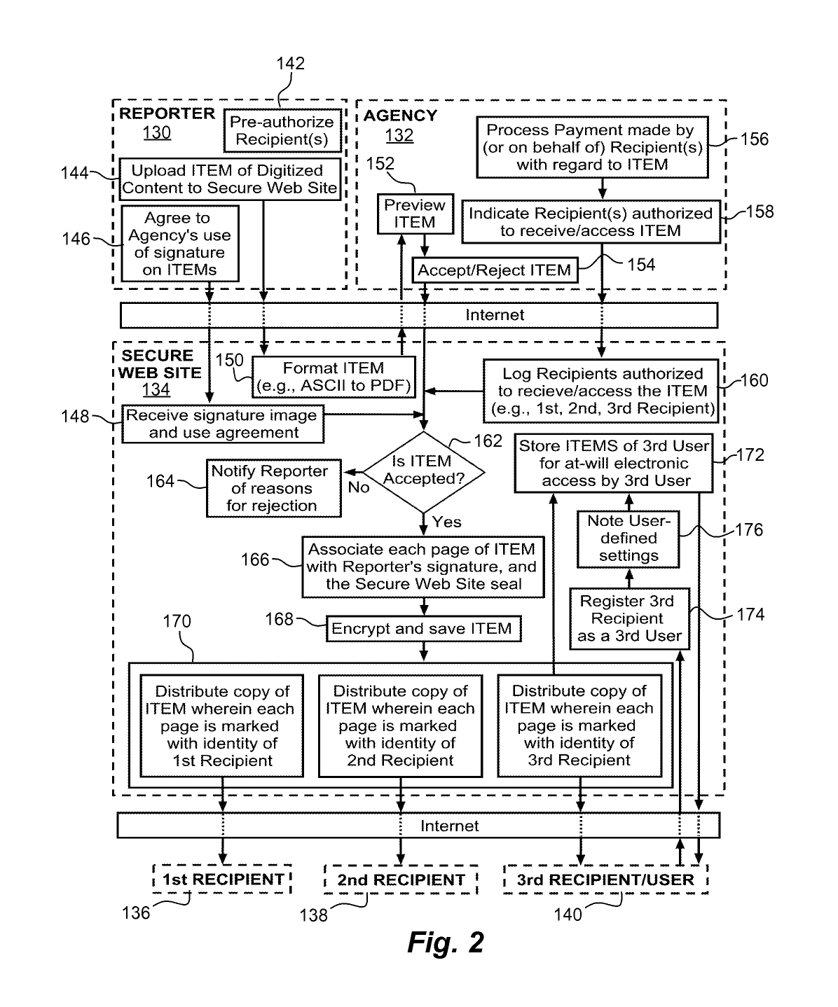

As illustrated for example in FIG. 2, an agency 132 may be furnished, by way of the secure website 134, preliminary access to at least the testimonial content and bibliographic content for approval (acceptance) or rejection thereof by the agency 132. Certain such embodiments may be configured or configurable so that the step of distributing 170 may be performed only upon the approval of (acceptance by) the agency 132. Moreover, certain such embodiments may be configured or configurable so that the step of distributing (illustrated at, for example, 116 and 170) is performed at least by way of email to the agency 132 of one or more of the marked document files for the agency to print out and send a hard copy of the one or more emailed marked document files to their respective authorized recipients. The agency 132 may, in some embodiments, be imparted the ability to edit the original digitized document file prior to the step of generating 114.

Referring to FIG. 2 for illustration, particular embodiments further comprise the steps of enrolling the document originator (e.g., reporter 130). As shown at block 148 for example, such enrollment may involve receiving from the originator 130 a signature image and the originator's assent to a use agreement. As illustrated in block 146, part of this enrollment process would typically involve the originator agreeing to the agency 132 being authorized to direct the secure web site 134 to apply the originator's signature on respective document files as part of, for example, an authentication process. In certain alternative embodiments, the originator 130 does not work with or through an agency, and therefore may themselves perform all of the roles and tasks of the agency 132 shown, for example, in the dashed agency block in FIG. 2. In each of these embodiments, the original digitized document would typically be received from the document originator 130. In certain such embodiments, after the step of distributing (see, e.g., blocks 116 and 170), the document originator 130 may be notified, for example via an originator web interface, that the respective marked document files have been distributed.

In particular embodiments, the method may further comprise steps which allow for rapid verification of the source of a printed copy of a marked document file, for example by way of a camera on a personal mobile device to scan such printed copy and communicate with the secure website 134. Such embodiments may include the step of establishing a bar code uniquely corresponding to each marked document file, wherein, (a) in the step of generating, substantially each of the pages is marked with the respective bar code, and (b) each bar code is configured to be scanned by a computing device in remote communication with the secure web site, thereby, for example, disclosing on a display screen the signature image and at least a portion of the bibliographic content of the respective marked document file.

In certain preferred embodiments, the original digitized document file is a proceeding transcript (e.g., an ITEM of digitized content as illustrated in FIG. 2) and the respective document originator is a reporter 130 having prepared the proceeding transcript. Such embodiments may optionally comprise further steps which allow for the secure storage and authentication of audio transcripts. Such embodiments, for example, may involve accepting an audio file including audio content corresponding with the testimonial content, and synchronizing the audio content with the testimonial content. In these embodiments, the marked document file may include the synchronized audio file such that the respective authorized recipients may listen to selected portions of the audio content while simultaneously reading corresponding portions of the testimonial content.

In particular embodiments, in the step of generating 114, substantially each of the pages is marked with an optical code unique to the respective marked document file, each optical code being scanable by a computing device (e.g., cell phone or tablet camera) configured to communicate with the secure website thereby retrieving and displaying a document dataset therefrom. Such document dataset may include, for example, verification information pertaining to the respective scanned marked document file, and the verification information may include at least a portion of the bibliographic content of the respective marked document file.

In certain preferred embodiments, the bibliographic content includes one or more of a header, an indication of document type, and a proceeding date. Moreover, embodiments may comprise the step of attaching to the marked document file, thereby making a portion thereof, one or more attachments selected from the group consisting of a witness certification page, an interpreter certification page, and an exhibit. In embodiments, the agency 132 may be the entity that adds the witness certification page, interpreter certification page, and/or exhibits.

In particular embodiments, at least one of the authorized recipients may be the trier of fact (e.g., the trial court or judge) in a proceeding which is the subject matter of the original digitized document file. In embodiments involving an agency 132, the agency may pre-authorize delivery of the transcript 178 to one or more of: non-registered recipients, registered users, and/or witnesses.

Referring again to FIG. 2, one or more possible elements of tasking and workflow of certain embodiments of the present invention are depicted. At block 144, the reporter 130 may upload the original item of digitized content to the secure web site 134, for example in ASCII format. Alternatively, in particular embodiments the reporter 130 may provide the original item of digitized content (e.g., proceeding transcript) directly to the agency 132, and the agency may upload the item to the secure website 134. As illustrated at block 150, the secure web site 134 may then format the uploaded item into another format such as PDF. As depicted at block 152, the secure web site 134 may provide the agency (or the reporter where there is no agency) an opportunity to preview the item and, as illustrated at 154, accept or reject it for distribution. As indicated at blocks 162 and 164, if the item is not accepted, the reporter 130 may be notified as to why, for example via email or a reporter web interface. This feature provides the reporter an opportunity to correct certain substantive or procedural defects in the original uploaded file, then re-upload that file. Also, in preferred embodiments, the reporter 130 may view and verify the deliveries of the item copies in a delivery log. The delivery log may form part of a reporter web interface provided by the secure web site.

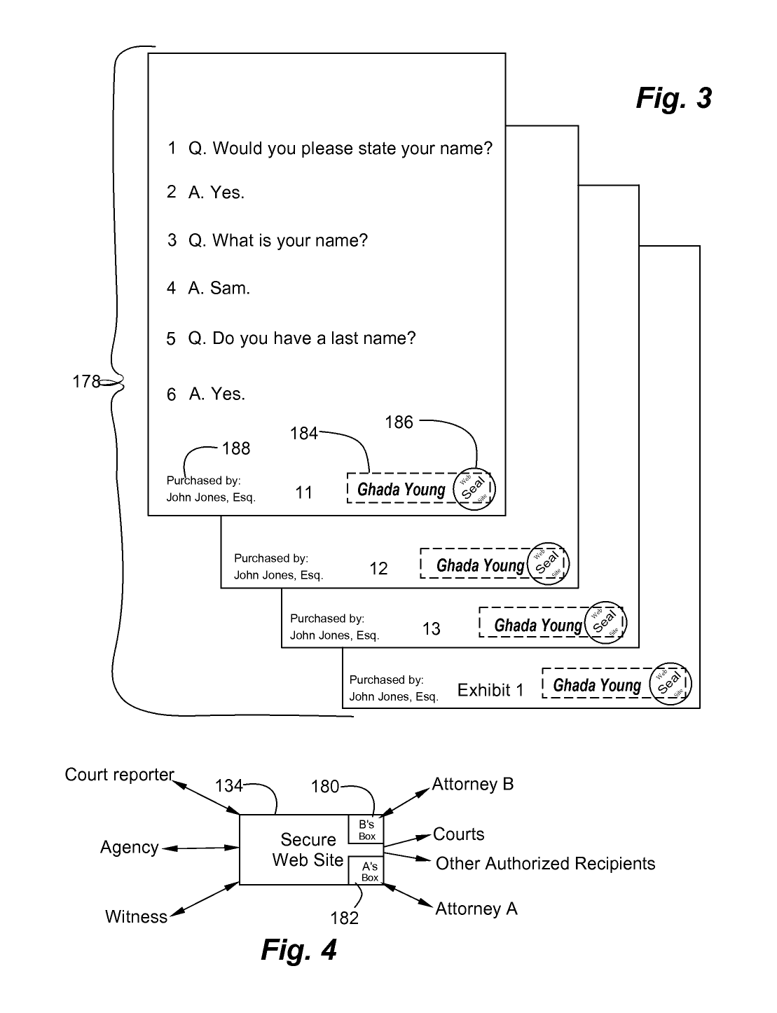

As illustrated at block 142, a reporter 130 may pre-authorize specific recipients as a result of, for example, the reporter 130 having received or processed payment from the respective pre-authorized recipient. Such pre-authorization may be indicated directly to the secure web site 134, or alternatively provided to an agency 132 which may then, as illustrated at block 158, indicate to the secure web site 134 who is authorized to receive and/or otherwise access the marked item of digitized content 178 (see, for example, FIG. 3). As illustrated at block 156, the agency 132 may process payment may by or on behalf of recipients with respect to specific items of digitized content. This payment processing may occur instead of, in conjunction with, or in addition to pre-authorization by the reporter 130 at block 142. As shown at block 160, once the authorized recipients are indicated to the secure website 134, the secure web site 134 may then log the recipients authorized to receive the item of digitized content, in for example, a database element.

As illustrated at block 166, if the item of digitized content is approved by the previewing entity (e.g., the agency 132), the secure web site 134 may then be configured to associate each page of the item of digitized content with the signature of the reporter 130 and the secure web site seal (see, for example, reference characters 184 and 186 respectively in FIG. 3). As shown at block 168, the item of digitized content may be encrypted and saved by the operators and/or components (e.g., servers) of the secure web site. As illustrated at block 170, copies of the respective documents may be distributed to authorized recipients (e.g., 136, 138 and 140) with substantially each page having been uniquely marked with the identity of the respective recipient (see, for example, 188 in FIG. 3), in addition to the originator 184 and web site seal 186.

The distributed marked document may appear to the recipient as shown diagrammatically at 178 in FIG. 3. As illustrated at block 174, certain recipients such as an attorney may choose to register directly with the secure web site 134 as a registered user (see 140 for example). As part of or following the user registration process, the registered user may then be able to input user-defined settings, including respective formatting preferences of the marked items distributed to them. As shown for example at block 176, such settings would then be noted by components of the secure web site 134. As illustrated at block 172, in addition or alternatively to the registered user having copies of the marked items sent to them (by way of, for example, email), the copy is stored by components of the secure web site 134 so that the registered user can access these marked items at-will. If the registered user chooses to modify his or her formatting preferences, he or she may re-view their respective stored items in the updated format. Preferably, registered users (e.g., attorneys A and B in FIG. 4) may be able to securely log on to the secure web site 134 by way of their respective mobile devices, and access their respective settings and authenticated documents (stored in their individual “boxes” A and B, at 180 and 182) wherever they are with convenience.

Certain embodiments in which an agency 134 is involved, the agency may perform the following steps in association with the secure web site 134: (a) Upload item(s) of digitized content to secure web site; (b) Indicate which reporter reported proceeding; (c) Preview the item; (d) Process payment made by (or on behalf of) recipient(s); (e) Authorize recipient(s) to access item [or just simply indicate recipient(s)]; and (f) Submit the item for processing & delivery (or cancel). It is contemplated that the preview can occur at any point (or more than once) after the upload. Step (d) may or may not happen (it may be up to the agency and their relationship with their client or other recipient). Step (a) made possibly plural depending upon whether the agency is uploading the transcript only or transcript plus exhibits.

A generalized process performed by the secure web site 134 in certain preferred embodiments may comprise the following steps: (a) Associate each page of the item with the reporter's signature and the secure web site seal; (b) Encrypt and store the item (c) Log recipient(s) authorized to receive/access the item; (d) Deliver the marked item(s) to recipient(s)′ emails (and/or make available on repository as per their preferences); (e) Notify reporter his/her signature was used on the distributed item(s); (f) If any email bounces back, notify the agency of the delivery failure.

According to certain embodiments, a preliminary distribution rule is established. This preliminary distribution rule provides that bibliographic data associated with at least one of the separate items of digitized content shall be proofed before the recipients or registered users are granted access to it. A payment distribution rule may be imposed in some embodiments on the distribution of the digitized content. According to this rule, a first recipient/user shall only have access to those separate items of content that the first said recipient/user has paid for. Also, at least a second said recipient/user shall only have access to those separate items of content that the second user has paid for. According to certain embodiments, a user identification distribution rule is implemented. Under this rule, each separate item of digitized content that is distributed to a first recipient 136 shall identify that first recipient (e.g., as shown at 188 in FIG. 3), and each separate item of content that is distributed to a second recipient 138 shall identify the second user.

According to certain embodiments, several distribution rules are established. These rules comprise at least a preliminary distribution rule for the editing of bibliographic data associated with items of digitized content, a payment distribution rule that limits the access of at least certain recipients/users to only the content that they have paid for, and a recipient/user identification distribution rule that causes each item of content that is distributed to a recipient/user to be marked with the identity of that recipient/user. These rules are not necessarily separated into discrete units that are applied one at a time by the operation of the secure web site. They are generally an integrated part of the overall operation of a secure web site, and they are applied as needed during such operation.

Under the preliminary distribution rule that is provided according to certain embodiments, proofing is carried out on bibliographic data, not substantive content. Bibliographic data, but not substantive data, is proofed with regard to both format and substance. For example, if the cover on a Court Reporter's transcript bears an incorrect address, a misspelling, or the wrong date, these errors would be corrected by a proofing step after the transcript is placed on the secure web site, and before it is permitted to be accessed by any of the users of the site. Such proofing does not extend to any changes in substantive content. It may include the automatic inclusion of disclaimers, discrete advertisements, or the like. For example, a content source such as a Court Reporter may request that all of that Reporter's transcripts automatically bear the address and phone number of both the Reporter and the Reporter's Agency. The results of such proofing may or may not be reviewed by the source of the content to which the bibliographic data applies before users are granted access to such content.

Embodiments wherein a payment distribution rule is imposed on items of digitized content limit access for at least some categories of users depending on payment. Access to any unit or part of the digitized content in the custody of a secure web site for at least certain classes of recipients/users is limited to those recipients/users for which such access has been paid. Not all categories of recipients/users may be treated equally in regard to payment for access. Courts of record and administrative tribunals may, for example, be granted access to selected portions of the digitized content without payment. Control of the access to digitized content by non-paying users (e.g., unregistered authorized recipients) is controlled by the content providers and/or the paying users. Thus, a deposition transcript might be made available to the Court where the matter to which the transcript relates is pending by the Court Reporter that took the deposition, or an attorney that purchased access to the deposition transcript. The payment distribution rule may provide for this and other categories of selective access depending on the payment requirements for a particular category of recipient/users. Such payment requirements may be assigned on an individual case-by-case basis to individual items of content, individual recipients/users, or categories of recipients/users, or globally for entire categories of content, or recipients/users.

Certain entities may have purchased several hundred separate items of digitized content over a period of time. For purposes of security, saving on paper, retrieving previous work product, and storage space such entities may desire to store all of their digitized content on a secure web site where access and distribution are strictly controlled. To this end, according to certain embodiments of the payment distribution rule, all of the digitized content that has been paid for by one entity is available to that entity whenever the secure web site is being operated. These distribution rules are equally applicable to situations where payments to the source of the content are based on the number of copies that are made of the content, and to situations where only a one-time payment covers any number of copies. A Court Reporter may, for example, be paid on the basis of how many copies are made. Where a very important document is digitized and stored on a secure web site, it is safe and accessible to those that are authorized to have access.

Generally access and distribution to individual registered users is password dependent. That is a user presents a password electronically, and the secure web site proceeds to process a request based on the assumption that the entity that entered the password is the entity that is associated with that password in the web sites records. Payments are associated with a password when they are received.

According to certain embodiments of the user identification distribution rule, if first and second users both purchase access to the same items of digitized content on the web site, each will be granted access to the same items. If both users download copies of the digital files that embody the purchased items, or print copies of the same items directly from the secure web site, these copies will reflect which user purchased them and copied them. Only the identity of the first user shall appear on copies of the paid for items that are distributed from the secure web site to the first user. Similarly, only the identity of the second user shall appear on copies that are distributed to the second user. The individual users cannot see from their copies who else has paid for a copy of those same items. If someone that has not purchased a copy of that content uses a copy, it is clear to anyone viewing the copy that it was not purchased by the person presenting it. Thus, for example, a Court can tell whether the attorney offering a transcript has paid for it.

In certain embodiments, a method of operating a secure web site for storing and distributing digitized transcripts that are authenticated may comprise (a) selecting a secure web site configured to receive, store and distribute a plurality of digitized transcripts, each of the transcripts originating from a respective reporter and stored and distributed as copies to one or more authorized recipients under controls that assure the authenticity of those copies, the secure web site including at least a server element; (b) obtaining respective reporter enrollment data from each of the reporters by way of the server element, the reporter enrollment data including an image of the signature of the respective reporter and authorization to affix the image to the copies of the transcripts which originated from the respective reporter; (c) receiving a list of the one or more authorized recipients for each of the transcripts; and (d) sending, by way of the server element, the copies of each of the transcripts to the respective authorized recipients, wherein each of the copies includes a multiplicity of pages, substantially each of the pages being marked with a seal of the secure web site, the respective signature image, and identification of the respective authorized recipient.

In similar or alternative embodiments to those that have already been disclosed herein, a method of operating a secure web site for storing and distributing digitized transcripts that are authenticated, may comprise the following steps: (a) selecting a secure web site that provides for the receipt, custody, and distribution of a plurality of digitized transcripts, each said transcript being received from a respective agency and stored and distributed as copies to one or more authorized recipients under controls that assure the authenticity of those copies distributed to respective said authorized recipients; (b) receiving a list of one or more authorized recipients; (c) establishing a recipient rule that only authorized recipients shall receive a copy of the respective item; (d) imposing a payment distribution rule that a first said user shall only have access to those of said plurality of separate items that the first said user has paid for, and that a second said user shall only have access to those of said plurality of separate items that the second said user has paid for; and (e) implementing a user identification distribution rule that each of those said plurality of separate items that is distributed to the first said user shall identify the first said user, and that each of those said plurality of separate items that is distributed to the second said user shall identify the second said user.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A non-transitory computer-readable storage medium storing one or more sequences of instructions which, when executed by one or more processors, causes the one or more processors to collectively perform the method comprising:
operating a secure website configured to receive, store and distribute digitized documents;
receiving, by way of the secure website, an original digitized document file having testimonial content, bibliographic content, and a respective named document originator;
acquiring a signature image unique to the document originator;
obtaining a list of authorized recipients having respective recipient identifications;
generating a marked document file corresponding to each of the authorized recipients, wherein each marked document file includes a multiplicity of pages and displays the testimonial content and the bibliographic content, substantially each of the pages being marked with:
(a) a website seal corresponding to the secure website,
(b) the signature image, and
(c) the respective recipient identification; and
distributing each marked document file for delivery to its respective authorized recipient.

2. The non-transitory computer-readable storage medium of claim 1, wherein the method further comprises:
enabling a witness to review the testimonial content, provide any corrections to the testimonial content, and input a witness signature for association with the testimonial content;
constructing a witness certification page displaying the witness signature; and
if the witness has provided any corrections, producing an errata sheet specifying the corrections;
wherein the step of distributing includes distributing the witness certification page and any respective errata sheet for delivery to each authorized recipient.

3. The non-transitory computer-readable storage medium of claim 1, wherein the step of distributing is performed at least by way of email to one or more of the respective authorized recipients.

4. The non-transitory computer-readable storage medium of claim 1, wherein the method further comprises:
registering one or more of the authorized recipients as one or more respective registered users;
storing the marked document files corresponding to the one or more registered users; and
providing repeatable remote electronic access by each of the one or more registered users to their corresponding stored marked document files.

5. The non-transitory computer-readable storage medium of claim 4, wherein the method further comprises:
allowing each of the one or more registered users to select respective formatting preferences;
recording the formatting preferences; and
formatting respective marked document files in accordance with the formatting preferences of its registered user.

6. The non-transitory computer-readable storage medium of claim 1, wherein the method further comprises:
furnishing, to an agency by way of the secure website, preliminary access to at least the testimonial content and bibliographic content for approval or rejection thereof by the agency;
wherein the step of distributing is performed only upon the approval of the agency.

7. The non-transitory computer-readable storage medium of claim 6, wherein the step of distributing is performed at least by way of email to the agency of one or more of the marked document files for the agency to print out and send a hard copy of the one or more emailed marked document files to their respective authorized recipients.

8. The non-transitory computer-readable storage medium of claim 6, wherein the method further comprises:
enrolling the document originator; and
after the step of distributing, notifying the document originator that the respective marked document files have been distributed;
wherein in the step of receiving, the original digitized document is received from the document originator.

9. The non-transitory computer-readable storage medium of claim 1, wherein the method further comprises:
establishing a bar code uniquely corresponding to each marked document file;
wherein, in the step of generating, substantially each of the pages is marked with the respective bar code; and
wherein each bar code is configured to be scanned by a computing device in remote communication with the secure website, thereby disclosing the signature image and at least a portion of the bibliographic content of the respective marked document file.

10. The non-transitory computer-readable storage medium of claim 1, wherein the original digitized document file is a proceeding transcript and the respective document originator is a reporter having prepared the proceeding transcript.

11. The non-transitory computer-readable storage medium of claim 10, wherein the method further comprises:
accepting an audio file including audio content corresponding with the testimonial content; and
synchronizing the audio content with the testimonial content;
wherein the marked document file includes the synchronized audio file such that the respective authorized recipients may listen to selected portions of the audio content while simultaneously reading corresponding portions of the testimonial content.

12. The non-transitory computer-readable storage medium of claim 10, wherein in the step of generating, substantially each of the pages is marked with an optical code unique to the respective marked document file, each optical code being scanable by a computing device configured to communicate with the secure website thereby retrieving and displaying a document dataset therefrom, the document dataset including verification information pertaining to the respective scanned marked document file, the verification information including at least a portion of the bibliographic content of the respective marked document file.

13. The non-transitory computer-readable storage medium of claim 1, wherein the bibliographic content includes one or more of a header, an indication of document type, and a proceeding date.

14. The non-transitory computer-readable storage medium of claim 1, wherein the method further comprises:
attaching to the marked document file, thereby making a portion thereof, one or more attachments selected from the group consisting of a witness certification page, an interpreter certification page, and an exhibit.

15. A method of operating a secure website configured to facilitate the receipt, storage and distribution of digitized documents, the method comprising:
receiving an original digitized document file having testimonial content, bibliographic content, and a respective named document originator;
acquiring a signature image unique to the document originator;
obtaining a list of authorized recipients having respective recipient identifications;
enabling a witness to review the testimonial content, provide any corrections to the testimonial content, and input a witness signature for association with the testimonial content;
constructing a witness certification page displaying the witness signature;
if the witness has provided any corrections, producing an errata sheet specifying the corrections;
generating a marked document file corresponding to each of the authorized recipients, wherein each marked document file includes a multiplicity of pages and displays the testimonial content and the bibliographic content, substantially each of the pages being marked with:
(a) a website seal corresponding to the secure website,
(b) the signature image, and
(c) the respective recipient identification; and
distributing for delivery to its respective authorized recipient:
(i) each marked document file,
(ii) any respective witness certification page, and
(iii) any respective errata sheet; and
registering one or more of the authorized recipients as one or more respective registered users;
storing the marked document files corresponding to the one or more registered users; and
providing repeatable remote electronic access by each of the one or more registered users to their corresponding stored marked document files.

16. The method of claim 15, further comprising:
allowing each of the one or more registered users to select respective formatting preferences;
recording the formatting preferences; and
formatting each marked document file in accordance with the formatting preferences of its respective registered user.

17. The method of claim 15, further comprising:
furnishing, to an agency by way of the secure website, preliminary access to at least the testimonial content and bibliographic content for approval or rejection thereof by the agency;
wherein the step of distributing is performed only upon the approval of the agency.

18. The computer-implemented method of claim 15, further comprising:
imparting to the agency the ability to edit the original digitized document file prior to the step of generating.

19. The computer-implemented method of claim 15, wherein the step of distributing is performed at least by way of email to the agency of one or more of the marked document files for the agency to print out and send a hard copy of the one or more emailed marked document files to their respective authorized recipients.

20. The method of claim 15, further comprising:
establishing a bar code uniquely corresponding to each marked document file;
wherein, in the step of generating, substantially each of the pages is marked with its respective bar code; and
wherein each bar code is configured to be scanned by a computing device in remote communication with the secure website, thereby disclosing the signature image and at least a portion of the bibliographic content of the respective marked document file.

21. The method of claim 15, further comprising:
accepting an audio file including audio content corresponding with the testimonial content; and
synchronizing the audio content with the testimonial content;
wherein the marked document file includes the synchronized audio file such that the respective authorized recipients may listen to selected portions of the audio content while simultaneously reading corresponding portions of the testimonial content.

22. The method of claim 15, wherein at least one of the authorized recipients is a trier of fact in a proceeding which is the subject matter of the original digitized document file.

23. A method of operating a secure web site for storing and distributing digitized transcripts that are authenticated, the method comprising:
selecting a secure web site configured to receive, store and distribute a plurality of digitized transcripts, each of the transcripts originating from a respective reporter and stored and distributed as copies to one or more authorized recipients under controls that assure the authenticity of those copies, the secure web site including at least a server element;
obtaining respective reporter enrollment data from each of the reporters by way of the server element, the reporter enrollment data including an image of the signature of the respective reporter and authorization to affix the image to the copies of the transcripts which originated from the respective reporter;
receiving a list of the one or more authorized recipients for each of the transcripts; and
sending, by way of the server element, the copies of each of the transcripts to the respective authorized recipients, wherein each of the copies includes a multiplicity of pages, substantially each of the pages being marked with a seal of the secure web site, the respective signature image, and identification of the respective authorized recipient.

24. A method of operating a secure web site for storing and distributing digitized transcripts that are authenticated, said method comprising:
selecting a secure web site that provides for the receipt, custody, and distribution of a plurality of digitized transcripts, each said transcript being received from a respective agency and stored and distributed as copies to one or more authorized recipients under controls that assure the authenticity of those copies distributed to respective said authorized recipients;
receiving a list of one or more authorized recipients;
establishing a recipient rule that only authorized recipients shall receive a copy of the respective item;
imposing a payment distribution rule that a first said user shall only have access to those of said plurality of separate items that the first said user has paid for, and that a second said user shall only have access to those of said plurality of separate items that the second said user has paid for; and
implementing a user identification distribution rule that each of those said plurality of separate items that is distributed to the first said user shall identify the first said user, and that each of those said plurality of separate items that is distributed to the second said user shall identify the second said user.
